(19) United States
(12) Patent Application Publication
(10) Pub. No.: US 2012/0169597 A1
(43) Pub. Date: Jul. 5, 2012

(54) PHYSICAL JOYSTICK FOR ELECTRONIC TABLET DEVICES

(75) Inventor: Tyson Liotta, Rockville, MD (US)

(73) Assignee: ThinkGeek, Inc., Fairfax, VA (US)

(21) Appl. No.: 13/342,505

(22) Filed: Jan. 3, 2012

Related U.S. Application Data
(60) Provisional application No. 61/429,332, filed on Jan. 3, 2011.

(51) Int. Cl. G06F 3/033

(52) U.S. Cl. 345/161

(57) ABSTRACT

Embodiments are directed to a physical joystick input device for use with tablet computers that utilize touch screen technology to receive user input through virtual user input graphical elements. The physical joystick comprises a base that attaches to the touch screen surface through a suction cup and provides conductivity between the user and touch screen surface through conductive felt attached to a support ring of the joystick. The joystick can be configured to be placed over a virtual D-pad or other interface portion of a tablet to transmit physical user input of directional commands to the virtual touch-screen input interface.

### CROSS-REFERENCE TO RELATED APPLICATIONS

The present application claims the benefit of the U.S. Provisional Application No. 61/429,332 entitled “Physical Joystick For Electronic Tablet Devices,” and filed on Jan. 3, 2011.

### FIELD

Embodiments of the invention relate generally to physical interfaces for electronic game devices.

### BRIEF DESCRIPTION OF THE DRAWINGS

Embodiments of the present invention are illustrated by way of example and not limitation in the figures of the accompanying drawings, in which like references indicate similar elements and in which:

FIG. 1 illustrates an electronic tablet with a virtual D-pad user input element.

FIG. 2 illustrates the use of a physical joystick input device in conjunction with the electronic tablet of FIG. 1, under an embodiment.

FIG. 3 is a perspective view of the physical joystick input device, under an embodiment.

FIG. 4 is a top view of the physical joystick input device of FIG. 3.

FIG. 5 illustrates the range of motion of an attached joystick on the surface of a tablet, under an embodiment.

FIG. 6 illustrates the components of a physical joystick and some example manufacturing dimensions, under an embodiment.

FIG. 7 is a bottom view of the physical joystick illustrating the configuration of conductive felt under an embodiment.

FIG. 8 is a bottom view of the physical joystick illustrating the configuration of conductive felt under an alternative embodiment

### BACKGROUND

The popularity of tablet computers, such as the Apple® iPad™ and other similar devices has led to the development and distribution of electronic games and other applications that were traditionally played on arcade-style video game machines or home computers with connected physical user interface elements, such as joysticks, steering wheels, game controllers with switches and knobs, and other similar input devices.

A tablet computer, or simply tablet, is a medium-sized mobile computer (e.g., 8 to 14 inches diagonal screen size) integrated into a flat touch screen and primarily using stylus, digital pen or fingertip input along with virtual onscreen interface elements in place of physical interface elements. For example, a tablet may incorporate a virtual onscreen keyboard in place of a physical keyboard. In order to provide a user interface to a game played on a tablet, certain graphical elements can be provided to allow the user to provide game input as if he or she were manipulating a physical input device. For example, a virtual onscreen joystick can be displayed on a tablet to allow the user to provide up, down, sideways, and diagonal motion through touch or stylus contact.

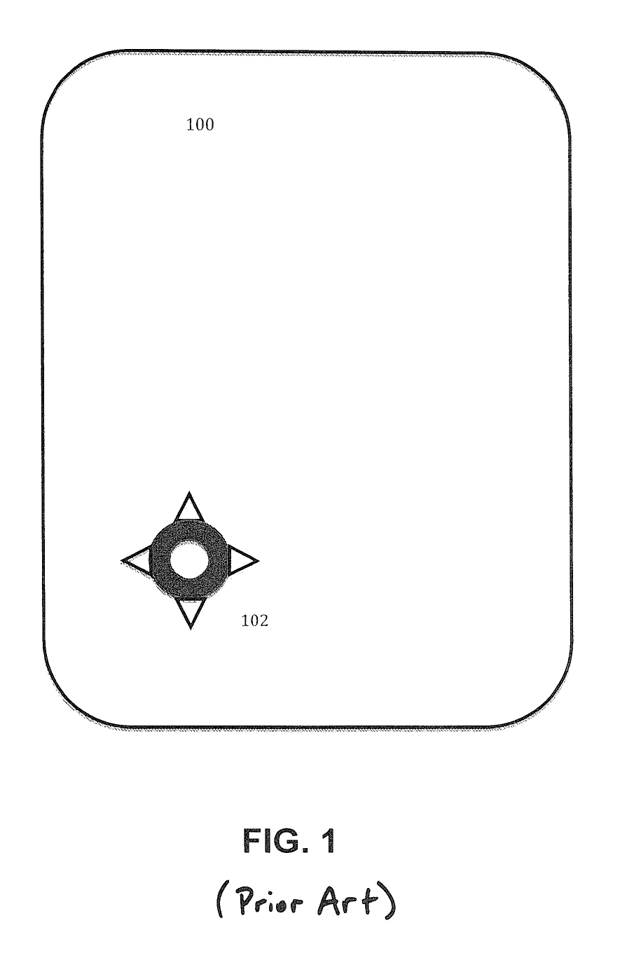

FIG. 1 illustrates a tablet device 100 with a virtual onscreen D-pad (directional pad) 102, The virtual onscreen D-pad can be displayed over an area of the screen that displays the game, or it can be displayed in a dedicated user interface area of the screen. The virtual D-pad 102 shown in FIG. 1 may be rendered so that it appears to be a three-dimensional representation of an actual joystick with a circular knob that can be moved in any direction up/down and left/right by the user touching the center circle and moving it in the direction of the displayed arrows. It can also be a representation of the traditional + (plus) shaped D-pad with the four directional arrows as each leg of the plus sign.

The virtual onscreen D-pad 102 allows a user to provide motion input as if the user were physically manipulating a real, physical joystick or directional pad. The virtual onscreen input thus provides some degree of enhanced user interaction with a game played on a tablet, however, it does not provide the feel and full user interaction with a game that an actual physical input device typically provides.

### DETAILED DESCRIPTION

Embodiments are directed to a physical input device that is affixed to the surface of a tablet screen proximate a virtual onscreen input element representing the physical input device, and provides physical input to a game or other application through manipulation of the virtual onscreen input element.

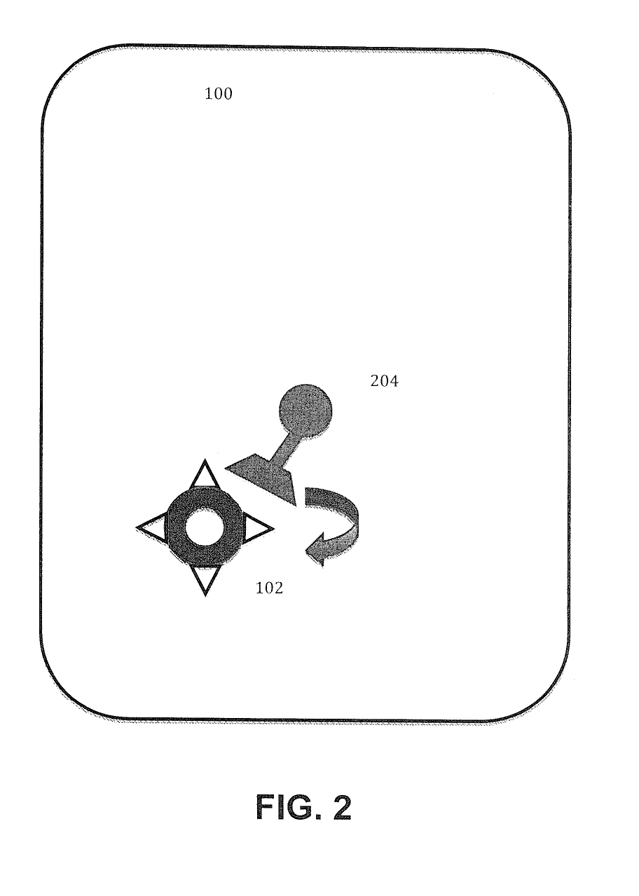

FIG. 2 illustrates a physical joystick input device used in conjunction with a tablet computer, under an embodiment. As shown in FIG. 2, a physical joystick device 204 is placed over the virtual onscreen input element 102. The control buttons, such as the virtual direction arrows and any virtual actuator buttons are then controlled by the user through direct handheld manipulation of the physical device, as opposed to contact on the touch screen surface by finger or hand. The physical joystick device 204 can be configured to be of a size and shape appropriate to the tablet or game device 100 as well as the virtual onscreen input element.

In an embodiment, the tablet 100 is a device that uses a capacitive touch screen to register user input. A touch screen (or “touchscreen”) generally refers to an electronic visual display that can detect the presence and location of a touch within the display area by either a person's hand or other passive device, such as a stylus. A capacitive touch screen consists of an insulator, such as glass coated with a transparent conductor that can sense a human body (also a conductor) causing a distortion of the screen's electrostatic field (measurable as a change in capacitance) when a person touches or contacts the screen. The location of the touch can be processed and this signal can then be used by the processor or device controller to register a user input.

Embodiments may be used with any appropriate type of touch screen, such as resistive touch screens in which two conductive layers are separated by a narrow gap and register a change in electrical current when an object, such as a finger, presses down on a point on the screen surface, and is registered as a touch event to be sent to the device controller for processing. Other types of applicable touch screens include Surface Acoustic Wave (SAW) screens that use ultrasonic waves that are absorbed when the screen is touched, infrared touch screens that use an array of infrared LED and photodetector pairs, optical imaging screens, dispersive signal screens, and other similar types of touch screens.

As shown in FIG. 2, the virtual user input element is a virtual representation of a D-pad interface. A D-pad (directional pad) interface, also known as a joypad, is a flat, usually thumb-operated directional control that is common in many video game consoles, game controllers, remote control units for televisions, VCR players, DVD, players, and so on. Typically four directional arrows are displayed on the D-pad to allow the user to move a cursor, icon, highlight bar or other graphic element either up and down or left and right across the screen. User interface processes can be further utilized to allow the user to move through virtually any degree of freedom along the two-dimensional plane defined by the surface of the tablet screen.

Different applications may use different virtual user input elements, other than the D-pad configuration. Embodiments of the physical input device can be configured to operate with any appropriate virtual user input element.

For the embodiment in which the virtual user input element 102 is a D-pad style input element, the physical input device 204 may be embodied as a joystick. As shown in FIG. 2 the joystick 204 is an input device consisting of a stick that pivots on a base and reports its angle or direction to the device it is controlling, in this case the tablet 100. The joystick 202 may comprise a simple shaft of a defined length, and it may incorporate one or more push-buttons whose state can be read by the game application or any other application running on the tablet 100.

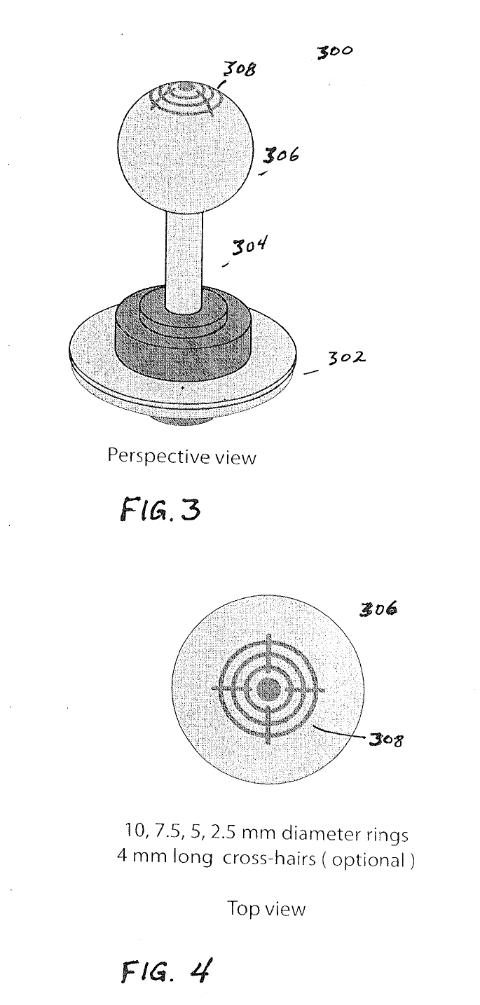

FIG. 3 is a perspective view of the physical joystick input device, under an embodiment. The joystick 300 comprises a base unit 302 for attachment to the surface of the tablet screen. A shaft 304 is coupled to the base and is rotatable relative to the base in virtually any direction. Alternatively, the shaft can be limited in its range of rotational motion through a gate or similar device in the base. The shaft is configured to pivot relative to the base and rotate along a plane parallel to the plane of the tablet screen surface. A knob 306 is attached to the top of the shaft 304 to facilitate holding or control by the user. The knob may be spherical (ball-shaped) or of any appropriate shape depending upon design and application requirements. The knob may have indicators 308 etched or painted onto the top surface to indicate direction and facilitate use. FIG. 4 is a top view of the physical joystick input device of FIG. 3. In an embodiment, the knob 304 has a cross-hair pattern 308 etched or printed onto its surface. The ball portion could also have a pattern of texture rings formed to facilitate holding or control by the user.

The physical joystick device 300 may be made of a specific size to match the tablet or pad 100 and the virtual input element 102. For example, if the tablet device 100 is a first generation Apple iPad with a diagonal screen size of 9.7 inches, the virtual graphic element 102 may be on the order of one-inch square or one-inch diameter. In this case, the physical joystick 300 may be a thumb-sized device that can be grasped by a person's fingers or controlled by thumb or single finger. In an embodiment, the joystick 300 is approximately 40 mm tall with a ball-shaped knob 306 that is on the order of 19 mm in diameter. The base 302 comprise a support ring of approximately 32 mm in diameter with one or more decorative rings of various diameters and thicknesses.

The joystick 300 may be made of aluminum, plastic, or any appropriate material and may be embodied in any appropriate shape and finish. FIG. 6 illustrates the components of a physical joystick and some example manufacturing dimensions, under an embodiment.

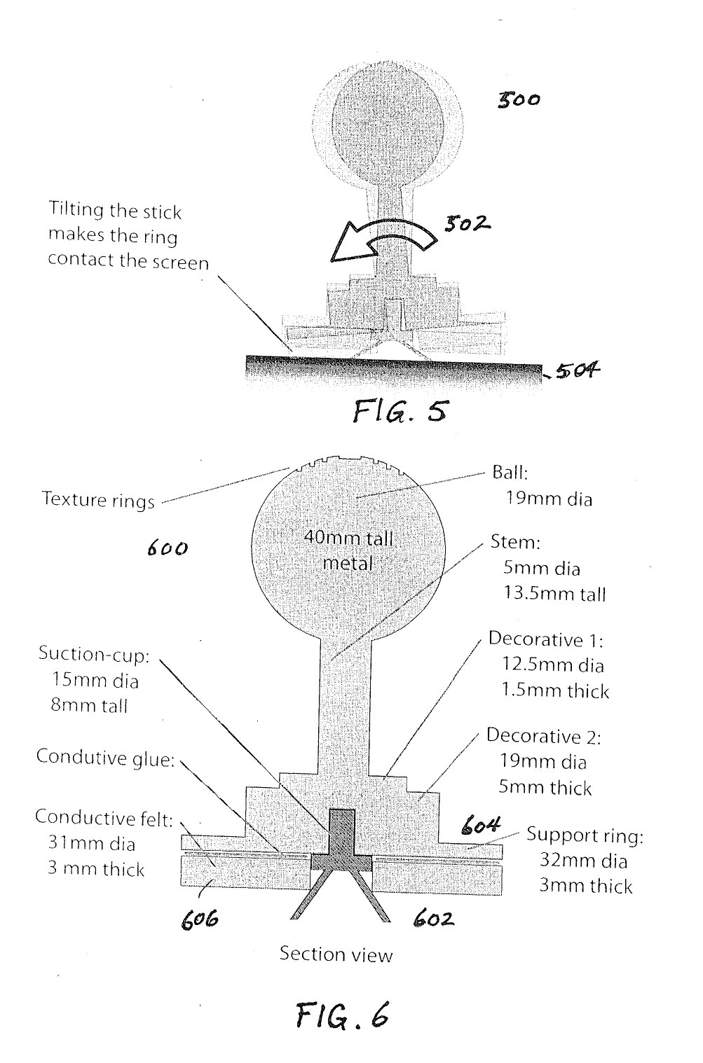

FIG. 5 illustrates the range of motion of an attached joystick on the surface of a tablet, under an embodiment. As shown in FIG. 5, when the joystick is affixed to the surface 504 of the tablet screen, it can be tilted, such as in the direction of arrow 502 to make contact with the appropriate area of the screen. Depending upon the virtual user input element (e.g., D-pad) on which the physical joystick 500 is placed, this tilt action will then be registered as user input through the virtual user input element. The joystick can be configured to tilt to any angle through a range of angles from perpendicular to the main axis of the base to a maximum tilt angle relative to the base. The joystick can be tilted to the maximum angle in any direction so that the joystick can be rotated in a circle when viewed from above and relative to the plane of the tablet surface.

In an embodiment, the joystick 300 is coupled to the surface of tablet 100 through a structure that provides both adhesion and capacitive conductivity to the touch screen surface. As shown in FIG. 6 the base portion of the joystick 600 includes a support ring to which is adhered a ring of electrically conductive felt 606. The conductive felt 606 is adhered to the support ring through conductive glue 607 that carries voltage between the felt and the main body of the joystick 600. The conductive portion comprising the conductive felt (or similar material and the conductive adhesive serves to conduct the appropriate electrical signal or electric property from the joystick to the touch-screen. The type of electrical signal conducted depends on the type of touch screen that is used. In the case of a capacitive touch screen, contact of the conductive portion against the touch screen by a user moving the joystick causes a change in capacitance similar to that of the user's finger against the touch screen. In the case of a resistive touch screen, contact of the conductive portion on the touch-screen is registered as a change in electric current. In the case of a SAW type screen, the contact is registered as a change in the ultrasonic wave field; and similar field changes are used for infrared, photodetector, optical imaging, and dispersive signal type touchscreens. In all of these cases, the location of the contact of the conductive portion is processed so that the electrical signal registers as user input through the joystick to the D-pad or other appropriate area on the touch screen device.

In the case of a tactile touch screen in which pressure is used to actuate a physical switch, such as a touch pad, the conductive portion of the joystick does not need to conduct an electrical signal, but rather simply needs to transmit the pressure from the user input to the surface of the touch-screen.

To affix the joystick 600 to the surface of the touch screen, a small suction cup 602 is press fit into a cavity in the body of the base structure. The suction cup can be made of any material (e.g., rubber, polyurethane, plastic, nylon, etc.), size and shape appropriate to hold the joystick 600 down onto the surface of the touch screen. In general, the configuration of the suction cup 602 is selected to be compatible with the material used in the touch screen, which is typically glass, but may be any other material, such as polycarbonate, plastic, Mylar, and the like.

In general, the joystick will typically be used in a horizontal or near horizontal configuration in which the tablet is resting on a horizontal surface, such as a table, desk or person's lap. Alternatively, it may be used in a vertical or near vertical application. In this case, the suction cup or other affixing means should be strong enough to hold the joystick against the surface for a minimum required amount of time. The support ring 604 may include one or more decorative portions 608, such as columns that strengthen or otherwise decorate the base section of the joystick 600. The size of each portion of the joystick can be specified in accordance with the device with which the joystick is used. For example, a small, miniature joystick may be used with a small device, such as a smartphone, netbook, or small (e.g., 6-7″) tablet, and a larger joystick may be used with a large tablet or laptop computer. In an example embodiment, such as shown in FIG. 6, in which the overall joystick is of a size of 40 mm tall, the ball portion could be on the order of 20 mm in diameter, the stem or shaft could be 14 mm tall with a 5 mm diameter, the support ring could be 32 mm in diameter with a thickness of 3 mm, the conductive felt could be a ring of 31 mm diameter and 3 mm thickness, the central suction cup could be of 15 mm diameter and a height of 8 mm, and one or more decorative base columns could be of varying thicknesses and diameters.

Depending upon the configuration and amount of conductive felt present in relation to the size of the support ring area, a single suction cup may be placed in the center of the support ring (as shown in FIG. 6) or an annular suction cup may be placed around the edge of the support ring. Alternatively, a number of suction cups may be placed between sections of the conductive felt in any appropriate pattern to provide sufficient attachment strength between the joystick and screen surface.

The conductive felt layer 606 may be of any shape, size, density and configuration appropriate to the touch screen technology utilized by the tablet 100 and the design of the virtual user input element 102. Any type of conductive felt, conductive foam, conductive plastic or metal mesh may be used depending on the requirement of the touch screen necessary to register user input through a tilting or pushing motion, as shown in FIG. 5.

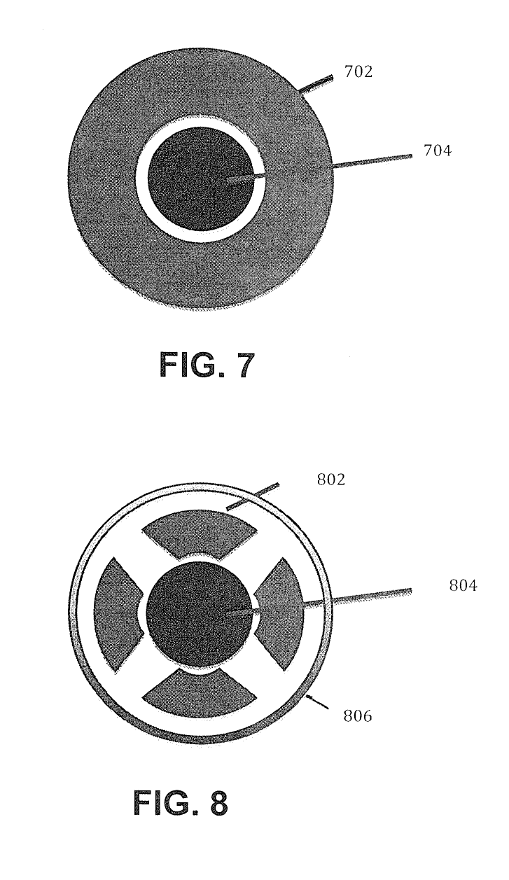

The conductive felt may be arranged on the underside of the support ring in any appropriate pattern to match the input patterns represented on the virtual input element of the tablet. FIG. 7 illustrates a bottom view of the joystick 600 with a ring shaped conductive felt section 702 surrounding a centrally located suction cup 704. FIG. 8 illustrates an alternative arrangement of the joystick 600 in which the conductive felt is arranged in separate contact patches 802 around a centrally located suction cup 804. The suction element may also be provided as an annular ring 806 placed around the rim of the support ring.

The size and placement of the conductive felt 606 is intended to simulate the touch of a user's finger when it is placed against the surface of the touch screen through tilting or pressing of the joystick. It provides a level of physical interface with the application or game running on the tablet computer in a way that is not possible through the virtual user input element alone.

Embodiments of the physical interface device can be embodied in any type of appropriate manual control device, such as a joystick, a steering wheel, a game controller, a switch or fader bank, and the like. The input device can be used in conjunction with any appropriate software or application process, such as gaming or productivity software, operating system functions, and the like. The input device can be used to control any appropriate aspect of the user interface to the software program, such as navigation control, GUI navigation, process execution, and the like.

Embodiments are directed to the use of physical interface devices with any type of touch screen based computing device, such as tablet computers, slate or pad devices, electronic readers (e-readers), personal gaming devices, personal digital assistants (PDAs), smart phones, netbook or notebook computers, and desktop or workstation computers that utilize a touch screen for user interface to applications or operating system software running on the tablet. Examples of typical tablet computers include pad computing devices such as the Apple® iPad™ and e-readers, such as the Amazon® Kindle™, and other similar devices.

Embodiments are directed to a joystick for use with a computing device with a touch-screen display comprising: a base unit for attachment to the surface of the touch-screen display; a shaft coupled to the base and configured to pivot relative to the base and rotate along a plane parallel to the plane of the touch-screen display; a support ring integral to the base unit and having adhered thereto a section of electrically conductive material through conductive glue to transmit an electrical signal between the joystick and the touch-screen display; and a suction cup press fit into a cavity in the base structure and configured to hold the joystick down onto the surface of the touch screen. The joystick further comprises a knob attached to the top of the shaft to facilitate holding and control by a user. The conductive material of the joystick may be selected from a group consisting of: conductive felt, conductive foam, conductive plastic, and metal mesh. The section of electrically conductive material comprises a ring shaped section conforming to the shape of the support ring.

The suction cup of the joystick can be made of a material selected from a group consisting of: rubber, polyurethane, plastic, and nylon. The suction cup may comprise a single suction element placed in the center of the support ring or it may comprise an annular suction cup laced around an edge of the support ring.

The touch-screen display may be selected from a group consisting of: a capacitive touch-screen, a resistive touch-screen, a Surface Acoustic Wave (SAW) screen, and an infrared touch screen.

Embodiments are further directed to a controller configured to be placed over a virtual directional pad displayed on a touch-screen display of a computing device, comprising: a base unit having a suction attachment for semi-permanent attachment to the surface of the touch-screen display over the directional pad; a shaft coupled to the base and configured to pivot relative to the base in one or more directions corresponding to directions of the directional pad; and a knob attached to the top of the shaft to facilitate holding and control by a user, wherein the controller is meant to represent a miniature joystick for applications in which the computing device comprises an electronic tablet or similar device.

Throughout the description and the claims, the words “comprise,” “comprising,” and the like are to be construed in an inclusive sense as opposed to an exclusive or exhaustive sense; that is to say, in a sense of “including, but not limited to.” Words using the singular or plural number also include the plural or singular number respectively. Additionally, the words “herein,” “hereunder,” “above,” “below,” and words of similar import refer to this application as a whole and not to any particular portions of this application. When the word “or” is used in reference to a list of two or more items, that word covers all of the following interpretations of the word: any of the items in the list, all of the items in the list and any combination of the items in the list.

The above description of illustrated embodiments is not intended to be exhaustive or to limit the embodiments to the precise form or instructions disclosed. While specific embodiments and examples are described herein for illustrative purposes, various equivalent modifications are possible within the scope of the described embodiments, as those skilled in the relevant art will recognize.

The elements and acts of the various embodiments described above can be combined to provide further embodiments. While certain aspects of the described embodiments may be presented in certain claim forms, the inventor contemplates the various aspects of the methodology in any number of claim forms. Accordingly, the inventor reserves the right to add additional claims after filing the application to pursue such additional claim forms for other aspects of the described systems and methods.

What is claimed is:

1. A joystick for use with a computing device with a touch-screen display comprising:
a base unit for attachment to the surface of the touch-screen display;
a shaft coupled to the base and configured to pivot relative to the base and rotate along a plane parallel to the plane of the touch-screen display;
a support ring integral to the base unit and having adhered thereto a section of electrically conductive material through conductive glue to transmit an electrical signal between the joystick and the touch-screen display; and
a suction cup press fit into a cavity in the base structure and configured to hold the joystick down onto the surface of the touch screen.

2. The joystick of claim 1 further comprising a knob attached to the top of the shaft to facilitate holding and control by a user.

3. The joystick of claim 1 wherein the conductive material is selected from a group consisting of: conductive felt, conductive foam, conductive plastic, and metal mesh.

4. The joystick of claim 3 wherein the section of electrically conductive material comprises a ring shaped section conforming to the shape of the support ring.

5. The joystick of claim 1 wherein the suction cup is made of a material selected from a group consisting of: rubber, polyurethane, plastic, and nylon.

6. The joystick of claim 5 wherein the suction cup comprises a single suction element placed in the center of the support ring.

7. The joystick of claim 5 wherein the suction cup comprises an annular suction cup laced around an edge of the support ring.

8. The joystick of claim 1 wherein the touch-screen display is selected from a group consisting of: a capacitive touch-screen, a resistive touch-screen, a Surface Acoustic Wave (SAW) screen, and an infrared touch screen.

9. The joystick of claim 1 wherein the computing device comprises an electronic tablet device.

10. A controller configured to be placed over a directional pad displayed on a touch-screen display of a computing device, comprising:
a base unit having a suction attachment for semi-permanent attachment to the surface of the touch-screen display over the directional pad;
a shaft coupled to the base and configured to pivot relative to the base in one or more directions corresponding to directions of the directional pad; and
a knob attached to the top of the shaft to facilitate holding and control by a user.

11. The controller of claim 10 wherein the computing device comprises an electronic tablet, and wherein the base, the shaft, and the knob are configured to represent a miniature joystick.

12. The controller of claim 11 further comprising a support ring integral to the base unit and having adhered thereto a section of electrically conductive material through conductive glue to transmit an electrical signal between the joystick and the touch-screen display.

13. The controller of claim 12 wherein the conductive material is selected from a group consisting of: conductive felt, conductive foam, conductive plastic, and metal mesh.

14. The controller of claim 13 wherein the section of electrically conductive material comprises a ring shaped section conforming to the shape of the support ring.

15. The controller of claim 11 wherein the suction attachment comprises a suction cup that is made of a material selected from a group consisting of: rubber, polyurethane, plastic, and nylon.

16. The controller of claim 11 wherein the touch-screen display is selected from a group consisting of: a capacitive touch-screen, a resistive touch-screen, a Surface Acoustic Wave (SAW) screen, and an infrared touch screen.

17. A physical controller for use with a virtual input pad of a computing device with a touch-screen display comprising:
base unit means for placement on the surface of the touch-screen display;
suction means to attach the base means to the surface of the touch-screen display.
shaft means for receiving physical user controls and by pivoting relative to the base and rotate along a plane parallel to the plane of the touch-screen display; and
conduction means for transmitting the physical user controls to the virtual input pad through electrical signals recognized by the touch-screen display.
